(19) United States
(12) Patent Application Publication
(10) Pub. No.: US 2002/0000702 A1
(43) Pub. Date: Jan. 3, 2002

(54) Transformable scooter

(76) Inventor: Philippe Charron, Montreal (CA)

Correspondence Address: MICHAEL D. BEDNAREK, SHAW PITTMAN, 2300 N STREET, N.W., WASHINGTON, DC, 20037-1128, US

(21) Appl. No.: 09/824,651

(22) Filed: Apr. 4, 2001

Related U.S. Application Data
(60) Provisional application No. 60/194,393, filed on Apr. 4, 2000.

(51) Int. Cl. B62M 1/00

(52) U.S. Cl. 280/87.021; 280/87.041; 280/87.05

(57) ABSTRACT

A transformable scooter is disclosed. The scooter transforms from a standing to a sitting configuration. The scooter includes a unique handle assembly that can extend and pivot to accommodate both standing and sifting riders. The scooter also includes a movable backrest that can be adjusted to support a standing or sitting rider. The scooter can also be motorized.

### RELATED APPLICATIONS

This Application claims the benefit of U.S. Provisional patent application No. 60/194, 393, filed on Apr. 4, 2000, the entirety of which is incorporated by reference.

### BACKGROUND

1. Field of the Invention

The present invention is directed to a moving vehicle. More specifically, the present invention is directed to a transformable scooter.

2. Background of the Invention

Conventional scooters generally fall into two categories. One category of scooter resembled a long skateboard with a raised handle bar. Those scooters where designed to support a standing rider who could steer the scooter by pivoting the front wheels by the raised handle bar. The standing scooters were also generally not powered, so riders provided propulsion by pedaling in a manner similar to the way skate boards are ridden. Mihalik, U.S. Pat. No. 4,203,610 and Lindau et al., U.S. Pat. No. 4,799,701 are examples of this type of scooter.

Another category of scooters was intended for use by the elderly, disabled, or other people requiring assistance in moving. These scooters where much more mechanically complex and were generally powered with electric motors. These scooters were also designed to support a seated rider. Blount et al., U.S. Pat. No. 5,036,938, Wu, U.S. Design Pat. No. D403,279, and Krause, U.S. Design Pat. No. D401,190 are examples of this type of scooter.

A third type of scooter is a modem, high-performance vehicle. These scooters are more akin to small motorcycles than the other two types of scooters discussed above. Kohyama, U.S. Pat. No. 4,697,664 and Takeshita et al., U.S. Design Pat. No. D399,174 are examples of this type of scooter.

Spielberger, U.S. Pat. No. 5,441,289 discloses a convertible walker/vehicle. However, the Spielberger device cannot be ridden in the standing configuration, and Spielberger's, conversion mechanism and process is complex: conversion requires the removal, inversion, and the re-installation of a frame member. Spielberger is also not motorized.

Generally, prior art scooters were designed to support either a sitting or standing rider. Prior art scooters generally could not convert from one mode of operation to the other. Additionally, while powered vehicles were available in the juvenile products market, no powered scooters have been available in that market.

### SUMMARY OF THE INVENTION

The invention is directed to a transformable scooter that can accommodate both a standing or a sitting rider.

In one aspect, the scooter includes a unique handle assembly that can extend and pivot to accommodate both standing and sitting riders.

In another aspect, the scooter also includes a movable backrest that can be adjusted to support a standing or sitting rider.

In another aspect, the scooter includes a rear portion and a forward portion. A handle portion is associated with the forward portion. The handle portion can extend with respect to the forward portion and can swivel with respect to the rear portion.

In other aspect, the scooter has a rear portion, a forward portion and a handle portion associated with the forward portion. The scooter can assume a first configuration where the handle portion is extended and where the rear portion is adapted to support a standing rider. In other words, a rider can stand on the rear portion and the handle portion is extended to be within reach of a standing rider. The scooter can also assume a second configuration where the handle portion is retracted and where the rear portion is adapted to support a seated rider.

In another aspect, the scooter includes a rear portion connected to a forward portion, and a handle portion associated with the forward portion. The scooter can assume a first configuration where the handle portion is extended and where a backrest disposed on the rear portion is pivoted downward. The scooter can also assume a second configuration where the handle portion is retracted and where the backrest disposed on the rear portion is pivoted upwards to provide a seat back for a sitting rider.

In another aspect, the scooter includes provisions that permit the scooter to be self-propelled. In other words, the scooter can include a motor and a motor control mechanism designed to permit a rider to operate the motor.

In another aspect, the scooter includes a speed selection switch capable of limiting an approximate maximum speed.

### BRIEF DESCRIPTION OF THE DRAWINGS

FIG. 1 is an isometric view of a preferred embodiment of a scooter in a first configuration according to the present invention.

FIG. 2 is a isometric view of a preferred embodiment of a scooter in a second configuration according to the present invention.

FIG. 3 is an isometric view of a preferred embodiment of a scooter in a collapsed, storage configuration according to the present invention.

FIG. 4 is a side elevation view of a preferred embodiment of a scooter according to the present invention.

FIG. 5 is a bottom view of a preferred embodiment of a scooter according to the present invention.

### DESCRIPTION OF A PREFERRED EMBODIMENT

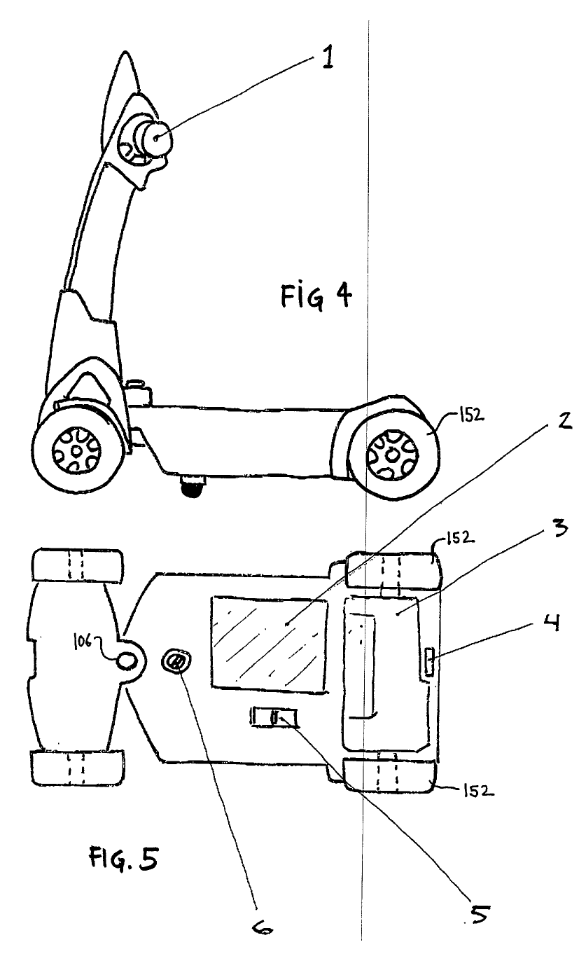

The scooter 100 includes a forward portion 102 and a rear portion 104. The two portions are connected by a joint that allows the forward portion 102 to pivot with respect to the rear portion 104. Preferably, a pivot pin 106 (see FIG. 4) is used to join the forward portion 102 and the rear portion 104. The forward portion 102 is connected to a handle portion 120. The scooter can be steered by riders turning the handle portion 120 thus turning the forward portion 102 and the front wheels 150 that are mounted to the forward portion 120. In this instance, the handle swivels about the pivot 106. In other words, handle portion 120 can swivel with respect to rear portion 104. As handle portion 120 swivels, forward portion 102 and wheels 150 connected to forward portion 102 swivel, permitting a rider to steer scooter 100. In the embodiment shown in the Figures, handle portion 120 is permanently attached to forward portion 102 and is not designed to be easily removed by a rider or an adult supervisor.

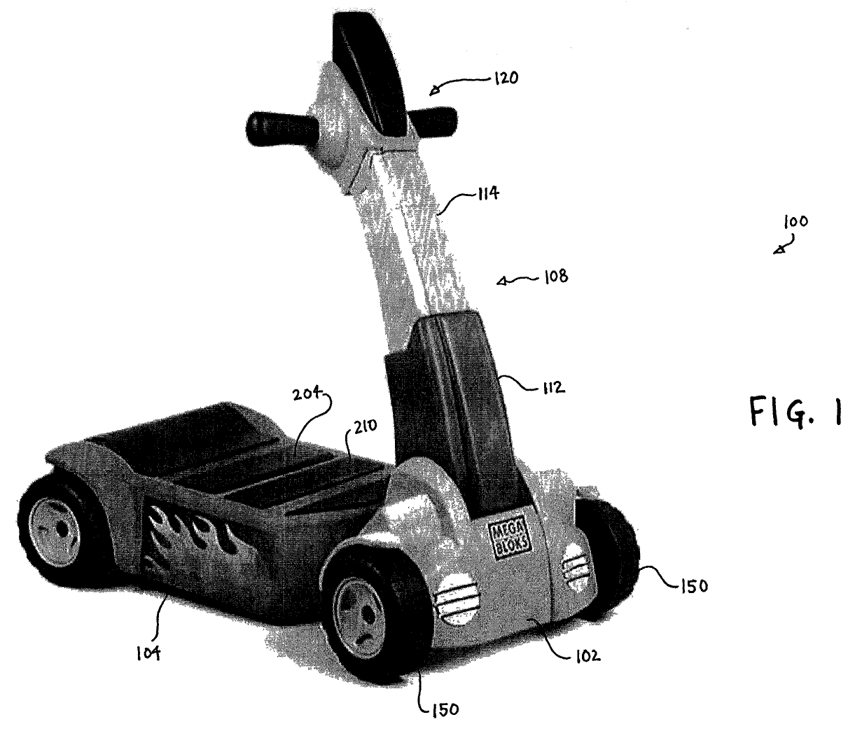

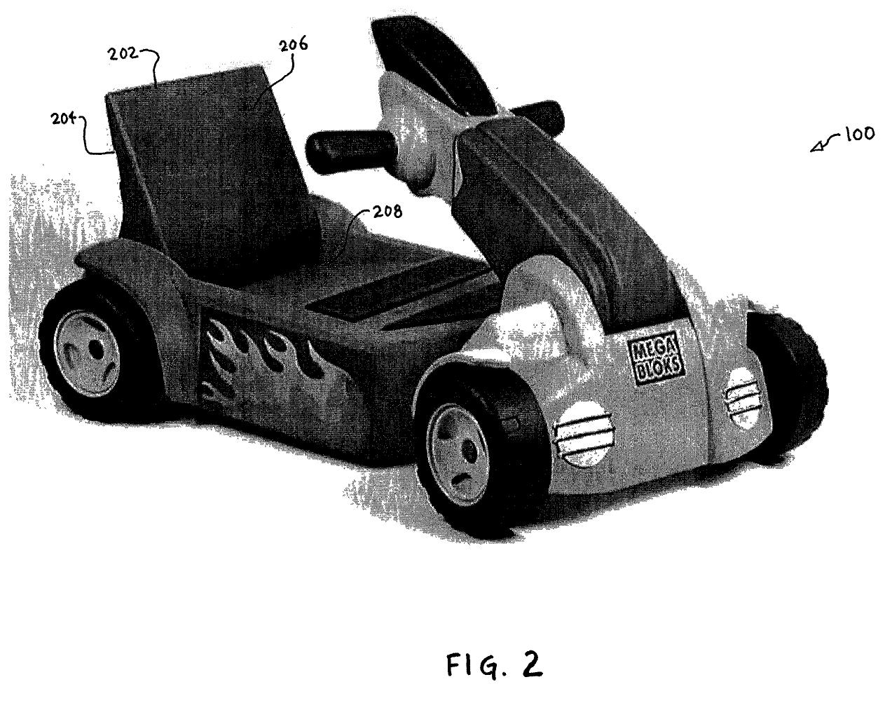

The forward portion includes a handle support 108. The handle support 108 is preferably telescopic, and includes a lower receiving portion 112 and an upper extending portion 114. The extending portion 114 is designed to retract telescopically toward the receiving portion 112 and extend telescopically away from the receiving portion 112. The extended position of the extending portion 114 is shown in FIG. 1 and the retracted position of the extending portion 114 is shown is FIG. 2.

The configuration show in FIG. 1 allows a standing rider to ride the scooter 100 in a manner similar to a conventional scooter. The scooter 100 can be optionally powered by a motor.

FIG. 2 shows the scooter 100 in a second configuration where the scooter 100 can be ridden by a seated rider. In this configuration, the handle support 108 is in the retracted position to attain a length that is convenient for a seated rider to grasp and operate. As shown in FIG. 2, handle support 108 can also be pivoted downward to assume a more acute angle with respect to rear portion 104. Additionally, a backrest 202 flips up from a stored position (the stored position shown in FIG. 1). The backrest 202 includes a back surface 204 that faces away from the rider when the rider is in the seated position, and a front surface 206 that faces the seated rider.

As shown more clearly in FIG. 1, the back surface 204 has a surface contour that matches the upper surface of the scooter's rear portion 104. Preferably, provisions to provide a slip-resistant surface are disposed on the upper surface of the scooter. Preferably, one or more protrusions or lands 210 are used to provide the slip-resistant surface. The protrusions or lands 210 can be made of a high-friction material, such as rubber, and can include slip resistant surface features, such as rough surface or a knurled profile.

Returning to FIG. 2, the front surface 206 supports the back of a rider. The front surface 206 is preferably contoured and curved to comfortably support the back of the rider. The backrest 202 emerges from a cavity 208. The cavity 208 houses the backrest 202 so that the back surface 204 of the backrest 202 is flush or even with the upper surface of the scooter's rear portion 104 (see FIGS. 1 and 4).

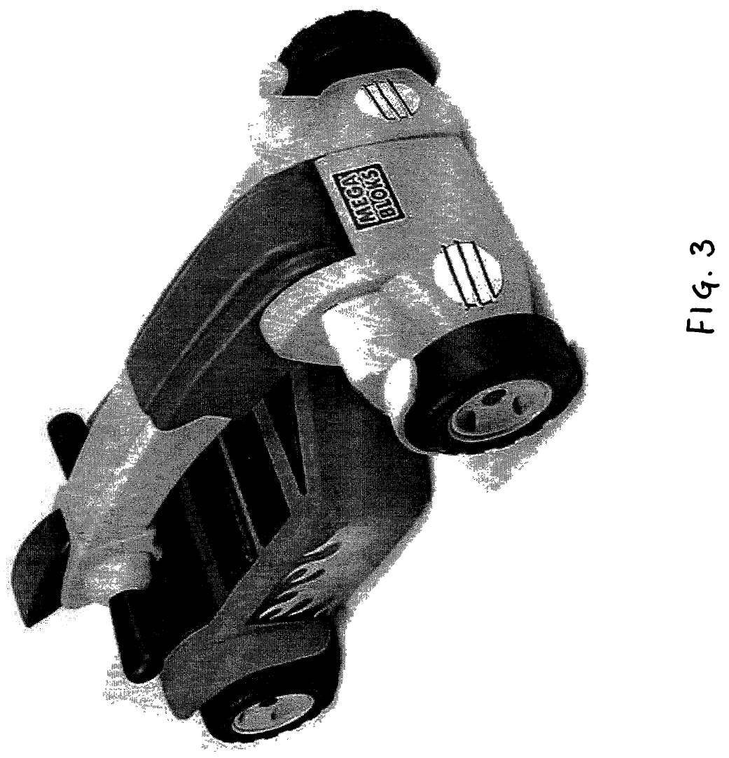

FIG. 3 shows a third, storage configuration of the scooter 100. In this configuration, the scooter attains a minimum height and is convenient for storage.

FIG. 4 is a side view of the scooter 100. Twist grip 1 is used to control the motor 3 (see FIG. 5) of the scooter. Preferably, twist grip 1 is a spring-loaded throttle control that is biased off. In other words, unless positive rotational force is applied to rotate twist grip 1 into an “on” or “go” condition, the twist grip 1 is in its “off” or “stop” rest position.

FIG. 5 shows the underside of the scooter 100. Components related to the propulsion of the scooter 100 can be seen from this view. A battery 2 provides power.

Preferably battery 2 is a 12 volt DC type battery. Preferably, the battery 2 is also replaceable. The battery 2 is connected to a motor 3 that drives the rear wheels 152 of the scooter 100. The motor 3 is preferably not designed to permit free wheeling. In other words, the motor 3 does not permit the free rotation of the rear wheels 152 unless motor 3 has been commanded to drive the wheels 152.

The battery 2 is also connected to a recharging port 4. The recharging port 4 is designed to electrically connect battery 2 to an outlet. A wall charger (not shown) can also be used to assist in recharging battery 2.

A speed selection switch 5 can also be optionally provided. The speed selection switch 5 allows parents, guardians or other supervisors of the rider to control the maximum speed of the scooter 100. Preferably the speed selection switch 5 allows the supervisor to switch between various speeds, including 2.5 mph and 5.0 mph. Preferably, speed selection switch 5 is tamper-resistant and child-resistant so that switch 5 can only be operated by an adult.

Scooter 100 can also optionally include a fifth wheel 6. The fifth wheel 6 is preferably centrally located, and relieves structural stresses that may exist in scooter 100. The fifth wheel can be a ball-and-socket type wheel, a swivel caster, or any other suitable wheel.

Any of the various components or features disclosed above can be used alone, with other existing components, or with components or features of the present invention.

It will be apparent to those skilled in the art that various modifications and variations can be made to the transformable scooter of the present invention without departing from the spirit or scope of the invention.

The foregoing disclosure of embodiments of the present invention has been presented for purposes of illustration and description. It is not exhaustive or intended to limit the invention to the precise forms disclosed herein. Many variations and modifications of the embodiments described herein will be obvious to one of ordinary skill in the art in light of the above disclosure.

I claim:

1. A scooter comprising:
a rear portion and a forward portion;
a handle portion associated with the forward portion; and
wherein the handle portion extends telescopically with respect to a forward portion and swivels with respect to the rear portion.

2. The scooter according to claim 1, wherein the handle portion also pivots with respect to the rear portion.

3. The scooter according to claim 1, further comprising a fifth wheel.

4. The scooter according to claim 1, further comprising a movable backrest.

5. The scooter according to claim 4, wherein the rear portion includes a cavity adapted to accommodate the movable backrest.

6. The scooter according to claim 1, further comprising a motor.

7. The scooter according to claim 6, further comprising a speed-selection switch capable of limiting an approximate maximum speed.

8. The scooter according to claim 6, wherein the motor is operated by a twist grip disposed on the handle portion.

9. A scooter having a rear portion, a forward portion and a handle portion associated with the forward portion including:
a first configuration wherein a handle portion is telescopically extensible and wherein the rear portion is adapted to support a standing rider; and
a second configuration wherein the handle portion is retracted and wherein the rear portion is adapted to support a seated rider.

10. The scooter according to claim 9, wherein a backrest is lowered in the first configuration and wherein the backrest is lowered in the second configuration.

11. The scooter according to claim 10, wherein the rear portion includes a cavity adapted to accommodate the movable backrest.

12. The scooter according to claim 9, wherein the rear portion includes at least one protrusion adapted to reduce slip.

13. The scooter according to claim 9, wherein the handle portion is permanently attached to the forward portion.

14. The scooter according to claim 9, further comprising a fifth wheel.

15. A scooter comprising:
a rear portion connected to a forward portion, and a handle portion associated with the forward portion wherein the scooter includes:
a first configuration wherein a handle portion is extended and wherein a backrest disposed on the rear portion is pivoted downward; and
a second configuration wherein the handle portion is retracted and wherein the backrest disposed on the rear portion is pivoted upwards.

16. The scooter according to claim 15, wherein a backrest is lowered in the first configuration and wherein the backrest lowered in the second configuration.

17. The scooter according to claim 15, wherein the handle portion is permanently attached to the forward portion.

18. The scooter according to claim 15, further comprising a fifth wheel.

19. The scooter according to claim 18, further comprising a speed-selection switch capable of limiting an approximate maximum speed.

20. The scooter according to claim 15, wherein the handle portion pivots with respect to the rear portion.
